(19) United States
(12) Patent Application Publication
(10) Pub. No.: US 2015/0296809 A1
(43) Pub. Date: Oct. 22, 2015

(54) PIZZA DOUGH AND METHOD FOR PRODUCING THE SAME

(71) Applicant: FUJI OIL COMPANY LIMITED, Izumisano-shi ,Osaka (JP)

(72) Inventors: Hiroyuki KANATANI, IBARAKI (JP); Norifumi ADACHI, IBARAKI (JP)

(21) Appl. No.: 14/649,207

(22) PCT Filed: Oct. 10, 2013
(86) PCT No.: PCT/JP2013/077557

§ 371 Date: Jun. 2, 2015

(30) Foreign Application Priority Data
Dec. 6, 2012 (JP) 2012-267614

(51) Int. Cl. A21D 2/36; A21D 2/22

(52) U.S. Cl. CPC A21D 2/362; A21D 2/22

(57) ABSTRACT

A pizza dough having good stretchability and workability and a crispy texture after baking without performing a retardation step for resting the dough prior to spreading is described. In producing the pizza dough, the stretchability of the same is improved by adding a water-soluble soybean polysaccharide, so the dough can be spread in a thin and uniform manner without performing a retardation step. In addition, it is possible to provide a pizza having good melt-in-the-mouth and crispy texture. The amount of the water-soluble soybean polysaccharide added is preferably 0.05 to 5 wt %, and more preferably 0.1 to 3 wt %, relative to the weight of the flour.

### FIELD OF THE INVENTION

The invention relates to pizza dough and a method for producing the same. The pizza dough has a better workability compared to a conventional one, and can be produced stably. Also, a pizza crust obtained from the pizza dough has good texture.

### DESCRIPTION OF THE RELATED ART

Typically, pizza dough is produced as follows: adding water to raw materials such as flour, salt, and oil and fat, kneading, dividing, and flat shaping by rolling (spreading). A pizza is produced by baking after topping cheese and other ingredients on the pizza dough, and the part derived from the dough is the pizza crust. In order to make a pizza with a crust of good crispy texture, the dough is kneaded into a thick weak-gluten membrane in a mixing step. Good crispy texture cannot be obtained if a thin strong-gluten membrane as in ordinary bread is formed.

However, dough prepared as a thick gluten membrane is hard and lacks stretchability, so it is easy to have the trouble of dough damage in spreading the dough. In a case of spreading manually by a skilled craftsman, the spreading can be controlled by delicate force adjustment, so there would not be a big problem. However, on using, for example, a machine like a spreading roller to thinly extend the dough, stretching of the dough is not sufficient, so there are problems such as cracks occurrence and surface roughness. For such reason, dough usually undergoes a so-called retardation step, that is, maturing (resting) under a low temperature condition for 30 min to about one night, in cases of spreading pizza dough by machines. By conducting a retardation step to the dough, its stretchability becomes better, and troubles during spreading decreases.

However, when a retardation step is conducted, large-scale equipment relating to cooling is necessary in line in cases of continuous production by machines. If the retardation step can be omitted, great laborsaving can be achieved from aspects of work space, work time and energy, and there is great cost merit. Therefore, several methods have been proposed.

In the method disclosed in the Patent Document 1, pizza dough is formulated by durum flour, rice flour and lecithin. However, in the studies of the inventors, the stretchability of dough is not sufficient when lecithin is less, and if the amount of lecithin is increased to promote stretchability, problems such as flavors derived from lecithin strongly coming out would appear. Further, though Patent Documents 2 and 3 are techniques utilizing an enzyme, the enzyme reaction is easy to fluctuate due to influences such as the temperature, so there is a problem that the quality of the final product is not stable.

### PRIOR-ART DOCUMENTS

### Patent Documents

Patent Document 1: JP H10-257847 A

Patent Document 2: JP 2010-81858 A

Patent Document 3: JP 2011-135810 A

### SUMMARY OF THE INVENTION

### Problems to Be Solved by the Invention

An issue of the invention is to obtain a novel method which is simple and effective as omitting a retardation step when producing pizza dough.

### Means for Solving the Problems

As a result of earnest studies to address the above-mentioned issue, the present inventors have ascertained that by adding a water-soluble soybean polysaccharide in the pizza dough, stretchability of pizza dough can be improved, a retardation step prior to dough spreading can be omitted, and pizza dough with good texture, crisp and melt-in-the-mouth taste can be further prepared, thus attaining the invention.

That is, the invention includes the following Items.
Item 1 is a pizza dough including a water-soluble soybean polysaccharide.
Item 2 is the pizza dough of Item 1 in which the content of the water-soluble soybean polysaccharide is 0.05 to 5 wt % relative to the flour.
Item 3 is a method for producing a pizza dough, which produces the pizza dough of Item 1 or 2 without performing a retardation step prior to the spreading.

### Effects of the Invention

With the invention, the stretchability of pizza dough is conveniently improved, so a retardation step prior to spreading can be omitted, and the work efficiency can be elevated and the equipment can be simplified. Further, pizza dough with crispy texture and good melt-in-the-mouth texture after baking can be provided.

### DESCRIPTION OF THE EMBODIMENTS

### Pizza Dough

In the invention, a pizza dough refers to a dough made by adding raw materials such as salt, oil and fat, and yeast to flour such as strong flour, medium flour or weak flour, adding water, kneading, and then flat shaping the resultant by rolling (spreading). The spreading can be made by a method of dividing the kneaded dough in a certain weight and then extending the dough by a spreading press machine, or a hollowing-out method of first spreading the dough without dividing and then die-cutting the dough to appropriate size. There are various shapes of pizza dough after spread shaping, but in general, a disk-shaped or oval-shaped ones are commonly used. The thickness of the pizza dough is about 1 mm to 10 mm, more preferably 2 mm to 5 mm.

Pizza dough made in this way can be eaten after a heating treatment such as baking, steaming, or cooking with oil. Also, the pizza dough can be refrigerated or frozen as is or after a heating treatment.

### Retardation Step

The retardation step of the invention refers to a step of making the state of dough suitable for spreading by resting it under a low temperature environment to make it easy for subsequent operations. Although the condition of the retardation step depends on the dough composition and the target physical properties, it usually allows the dough to stand still for 15 minutes to 24 hours at −20 to 10° C., and more preferably allows the dough to stand still for 15 minutes to 18 hours at −15 to 5° C. Usually, the retardation step conducted prior to a spreading step is effective, and a feature of the invention is being able to omit the retardation step.

### Water-Soluble Soybean Polysaccharide

A water-soluble soybean polysaccharide useful in the invention refers to a water-soluble polysaccharide extracted from soybean, and the method for producing the same is not particularly limited. In general, the water-soluble soybean polysaccharide is extracted under weak acidity (isoelectric point of soybean protein) and a high temperature condition over 100° C. from bean curd refuse (byproduct after extracting isolated soybean protein) as a raw material after addition of water. The extracted water-soluble soybean polysaccharide may be used as raw material in the form of extracted liquid directly, and may also be used after undergoing a purification step, such as activated carbon processing or desalting.

The amount of the added water-soluble soybean polysaccharide is preferably 0.05 to 5 wt % and more preferably 0.1 to 3 wt %, relative to the weight of the flour. It is difficult to obtain the target effect when the amount is less than 0.05 wt %. If the amount is more than 5 wt %, subsequent workability tends to deteriorate due to soggy dough.

The water-soluble soybean polysaccharide of the invention can have various forms such as powdery form, granular form and liquid form. The method for adding the water-soluble soybean polysaccharide may be mixing the water-soluble soybean polysaccharide as a powder with other raw materials. The water-soluble soybean polysaccharide can also be used after being added into an aqueous solution or the like in advance, or be used in the form of being dissolved in an aqueous phase of margarine etc. in advance.

### Combination with Other Functional Materials

The water-soluble soybean polysaccharide used in the invention can be combined with other bakery quality improvers such as thickening polysaccharide, emulsifier, enzyme, and reducing agent, without any disadvantage.

### Effects of the Invention

The invention is a technique in which a water-soluble soybean polysaccharide and other raw materials are added and mixed together to conveniently improve the stretchability of dough, and then flat shaping can be done without performing a retardation step. Also, with the technique, stretchability of dough can be raised and shrinkage of dough after thin-spreading can also be reduced, so dough with a uniform shape can be produced. Further, pizza dough with crispy and good melt-in-the-mouth textures after baking can be provided.

### EXAMPLES

Examples are shown below to explain the effects of the invention in detail.

### Experimental Example 1 (Evaluation of Dough Stretchability)

### Examples 1 to 6, Comparative Examples 1 to 2

Each dough was prepared according to a simply assumed formula of pizza dough (Table 1). Specifically, strong flour (Eagle, from Nippon Flour Mills Co., Ltd.), and, relative to the strong flour, 1.8 wt % of salt (salt, from Japan Salt Business Co., Ltd.), 100 ppm of ascorbic acid (ascorbic acid, from Fuso Chemical Co., Ltd.), 0.05 to 5 wt % of a water-soluble soybean polysaccharide (Soyafibe-S, from Fuji Oil Co., Ltd.) and 60 to 65 wt % of water were put in a quart mixer (AM-20; Aicoh Co., Ltd.) and mixed under conditions of 5 min of a low speed, 6 min of a medium speed and a kneading temperature of 22° C. The dough was divided to 150 g after resting for 10 min under the condition of a temperature of 21° C. and 70% humidity. After being rounded and passing a molder, each dough of Examples 1-6 and Comparative Example 1 was put onto an extensograph (Brabender Inc.) immediately without a retardation step, and the extension resistance (R) (tensile strength (BU) when the dough was extended for 5.0 cm) and the extension degree (E) (dough length (mm) when extended to snapping) are measured.

In addition, the dough of Comparative Example 2 underwent a retardation step of 60 min in a refrigerator of −2° C., and was then measured for the extension resistance (R) and the extension degree (E) using the extensograph. The dough stretchability was evaluated by calculating the R/E ratio from the measured values.

TABLE 1
Evaluation of Dough Stretchability

| | | | | | | | | | Comparative | Comparative | |
|---|---|---|---|---|---|---|---|---|---|---|---|
| | | | Ex. 1 | Ex. 2 | Ex. 3 | Ex. 4 | Ex. 5 | Ex. 6 | Example 1 | Example 2 | |
| Composition | Strong flour | (wt %) | 100 | ← | ← | ← | ← | ← | ← | ← | |
| | Salt | | 1.8 | ← | ← | ← | ← | ← | ← | ← | |
| | Water-soluble soybean | | 0.05 | 0.1 | 0.5 | 1.5 | 3 | 5 | — | — | |
| | polysaccharide | | | | | | | | | | |
| | Water | | 60 | 60.1 | 60.5 | 61.5 | 63 | 65 | 60 | ← | |
| | Ascorbic acid | (ppm) | 100 | ← | ← | ← | ← | ← | ← | ← | |
| Step | Retardation condition | none | 7.9 | ← | ← | ← | ← | ← | ← | −2° | C. |
| | | | | | | | | | | 60 | min |

| | | | | | | | | | |
|---|---|---|---|---|---|---|---|---|---|
| Evaluation | Stretchability (R/E) | 7.9 | 7.4 | 7.2 | 6.9 | 6 | 5.1 | 9.5 | 8.1 |

Ex.: Example

The results are shown in Table 1. The dough of Comparative Example 1 was hard and lacked stretchability as not undergoing a retardation step, but each dough of Examples 1 to 6, which either didn't undergo a retardation step, still had good dough stretchability. The effect was sufficient even compared to Comparative Example 2, which recovered stretchability by a retardation step.

### Experimental Example 2 (Evaluation of Dough Stability)

### Examples 7 to 10, Comparative Example 3

Each dough was prepared according to a formula shown in Table 2. After mixing was conducted mixing under conditions of 5 min of a low speed, 6 min of a medium speed, 5 min of a high speed and a kneading temperature of 22° C., floor time of 10 min was taken under the condition of a temperature of 21° C. and 70% humidity. After being divided to 250 g and rounded, the dough was spread to a thickness of 5 mm by a reversible sheeter. Two points with an interval of 15 cm were marked on the surface of the dough immediately after the dough came out from the reversible sheeter. The distance change between the two points was measured after the dough was placed still on the sheeter for 4 min.

TABLE 2
Evaluation of Stability (Shrinkage after Spreading)

| | | | | | | | Com- |
|---|---|---|---|---|---|---|---|
| | | | | | | | parative |
| | | | Ex. | Ex. | Ex. | Ex. | Exam- |
| | | | 7 | 8 | 9 | 10 | ple 3 |
| Com- | Strong flour | (wt %) | 100 | ← | ← | ← | ← |
| posi- | Salt | | 1.8 | ← | ← | ← | ← |
| tion | Water-soluble | | 0.1 | 0.5 | 1.5 | 3 | — |
| | soybean | | | | | | |
| | polysaccharide | | | | | | |
| | Water | | 45 | 45.5 | 46.5 | 48 | 45 |
| | Ascorbic acid | (ppm) | 100 | ← | ← | ← | ← |
| Eval- | Distance between | (cm) | 13.4 | 13.6 | 14.0 | 14.2 | 13.1 |
| ua- | two points | | | | | | |
| tion | Shrinkage length | | 1.6 | 1.4 | 1.0 | 0.8 | 1.9 |

Ex.: Example

The results are shown in Table 2. As shown in Examples 7 to 10, compared to Comparative Example 3, each dough added with a water-soluble soybean polysaccharide had less shrinkage after being spread using the reversible sheeter, so the stability thereof after shaping was high.

### Test Example (Preparation of Pizza Dough)

### Examples 11 to 16, Comparative Examples 4 to 5

Each pizza dough was prepared according to a formula in Table 3. Specifically, strong flour, and, relative to the strong flour, 1.8 wt % of salt, 2 wt % of powdered skim milk, 3.2 wt % of yeast, 100 ppm of ascorbic acid, 0.1 to 3 wt % of a water-soluble soybean polysaccharide (Soyafibe-S, Fuji Oil Co., Ltd.) and 60 to 63 wt % of water were put into a quart mixer. Kneading was conducted under 3 min of a low speed, 4 min of a medium speed and a temperature of 25° C. A primary fermentation was conducted under at 29° C. and 70% humidity for 40 min. After being divided to 150 g and rounded, each dough of Examples 11 to 16 and Comparative Example 4 was immediately spread to a disk shape with a thickness of 3 mm by a reversible sheeter without undergoing a retardation step, while the dough of Comparative Example 5 was spread by the same step after a retardation step for 2 hours at −6° C. After each spread dough was baked in an oven at 240° C. for 15 min, the workability during spreading and the texture of each dough compared to Comparative Example 5 were evaluated as follows. In addition, the texture was calculated as an average value of 5 panelists.

TABLE 3
Composition and Evaluation of Pizza Dough

| | | Ex. | Ex. | Ex. | Ex. | Ex. | Ex. | Comparative | Comparative | |
|---|---|---|---|---|---|---|---|---|---|---|
| | | 11 | 12 | 13 | 14 | 15 | 16 | Example 4 | Example 5 | |
| Composition | Strong flour | 100 | ← | ← | ← | ← | ← | ← | ← | |
| | Salt | 1.8 | ← | ← | ← | ← | ← | ← | ← | |
| | powdered skim milk | 2 | ← | ← | ← | ← | ← | ← | ← | |
| | Yeast | 3.2 | ← | ← | ← | ← | ← | ← | ← | |
| | Water-soluble soybean | 0.05 | 0.1 | 0.5 | 1.5 | 3 | 5 | — | — | |
| | polysaccharide | | | | | | | | | |
| | Water | 60 | 60 | 60.1 | 60.5 | 61.5 | 65 | 60 | ← | |
| | Ascorbic acid | 100 | ← | ← | ← | ← | ← | ← | ← | |
| Step | Retardation condition | none | ← | ← | ← | ← | ← | ← | −6° | C. |
| | | | | | | | | | 2 | hr |
| Evaluation | Workability | 4 | 4 | 5 | 5 | 5 | 5 | 1 | 3 (Refer- | |
| | (Evaluated by one person) | | | | | | | | ence) | |
| | Texture | 3.6 | 3.8 | 4.2 | 4.4 | 4.6 | 4.8 | 1.5 | 3 (Refer- | |
| | (Average value of 5 people) | | | | | | | | ence) | |

Ex.: Example

### Workability During Spreading

5: Compared to Comparative Example 5, the dough was fully extended, and the shrinkage after extension was small, so the dough could be stably spread.
4: Compared to Comparative Example 5, the extension of dough was good, and the shrinkage after extension was less; the dough could be easily spread.
3: The workability was almost the same as Comparative Example 5.
2: Compared to Comparative Example 5, the extension of dough was worse, and the shrinkage after extension was more; the dough shape after spread was not stable.
1: Compared to Comparative Example 5, the dough was hard and could not be extended, and dough damage was observed in spreading.

### Texture

5: The pizza had very good crispy texture and excellent melt-in-the-mouth texture.
4: The pizza had good crispy and melt-in-the-mouth texture.
3: Reference evaluation.
2: The pizza lacked crispy texture, and melt-in-the-mouth texture was also not so good.
1: The pizza had heavy dry-and-crumbly texture, and bad melt-in-the-mouth texture.

The results are shown in Table 3. Comparative Example 4 lacked stretchability for no retardation step was conducted after rounding, and dough damage such as cracks was observed in spreading. Also, the thickness of dough after spreading was observed to be uneven, and it was difficult to spread the dough in a uniform shape. Further, the texture after baking was dry-and-crumbly, and had bad melt-in-the-mouth texture. Hence, Comparative Example 4 is not suitable for pizza dough. On the other hand, each dough added with a water-soluble soybean polysaccharide as shown in Examples 11 to 16 had excellent stretchability and stability even without undergoing a retardation step, and also had good workability even compared to Comparative Example 5, which underwent a retardation step of 2 hours. Further, the texture after baking was not dry-and-crumbly in mouth. Each dough added with a water-soluble soybean polysaccharide as shown in Examples 11 to 16 was pizza dough with crispy and excellent melt-in-the-mouth texture.

1. A pizza dough, comprising a water-soluble soybean polysaccharide.

2. The pizza dough of claim 1, wherein a content of the water-soluble soybean polysaccharide is 0.05 to 5 wt % relative to flour.

3. The pizza dough of claim 1, wherein a content of the water-soluble soybean polysaccharide is 0.1 to 3 wt % relative to flour.

4. The pizza dough of claim 1, a ratio of R (extension resistance) to E (extension degree) of which ranges from 5 to 8.

5. The pizza dough of claim 2, a ratio of R (extension resistance) to E (extension degree) of which ranges from 5 to 8.

6. The pizza dough of claim 3, a ratio of R (extension resistance) to E (extension degree) of which ranges from 5 to 8.

7. A method for producing the pizza dough of claim 6, which uses ascorbic acid.

8. A method for producing the pizza dough of claim 6, without performing a retardation step prior to spreading.

9. A method for producing the pizza dough of claim 6, which uses ascorbic acid without performing a retardation step prior to spreading.
